(19) United States
(12) Patent Application Publication
(10) Pub. No.: US 2004/0049695 A1
(43) Pub. Date: Mar. 11, 2004

(54) System for providing a real-time attacking connection traceback using a packet watermark insertion technique and method therefor

(76) Inventors: Yang Seo Choi, Daejeon (KR); Byeong Cheol Choi, Daejeon (KR); Dong Ho Kang, Daejeon (KR); Seung Wan Han, Gwangju (KR); Dong II Seo, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/329,270

(22) Filed: Dec. 24, 2002

(30) Foreign Application Priority Data
Sep. 6, 2002 (KR) 2002-53905

(51) Int. Cl. G06F 11/30

(52) U.S. Cl. 713/200

(57) ABSTRACT

In a system for providing a real-time attacking connection traceback, an intrusion detection unit detects a hacker's attack. A packet block unit blocks a response of an attacked system. A path block tracing unit generates a policy to block a specific packet, collects a response packet, inserts the generated watermark in the packet, transmits the watermark-inserted packet to a system and forms a traceback path. A watermark detection unit checks a received/transmitted packet in a network, extracts a corresponding watermark if there exists the watermark-inserted packet and transmits the watermark-inserted packet detection information to an attacking connection traceback system that initially inserted a watermark into a packet.

### FIELD OF THE INVENTION

The present invention relates to a system and method for tracing back the source of intrusion over the Internet; and, more particularly, to a system for providing a real-time attacking connection traceback (hereinafter, referred to as ACT) using of a packet watermark insertion technique and a method therefor.

### BACKGROUND OF THE INVENTION

Recently, there have been introduced various techniques capable of tracing causes of damages generated by hackers in order to prevent frequent cyber terrors intended by the hackers.

To that end, it has been raised that a traceback module is installed in every host on the Internet or a hacker location tracing system employing a specific function for providing existing application programs with a traceback is required.

However, it is difficult to completely realize such systems in a current Internet environment.

Referring to FIG. 1, there is illustrated a general hacking process. A hacker 110 in a network 140 first attacks a system 120 in a network 150. Next, the hacker 110 secondly attacks a system 130 in a network 160 by using a specific authority obtained from the first attack on the system 120, thereby performing a final attack.

In this case, there may be two or more systems attacked by the hackers despite emphasis on the two attacked system. The system may be damaged in such a manner that the hacker accesses the system 120 by performing a normal login process. The information on a system in which the hacker is located cannot be obtained from the system 130, so that the system 120 should be examined for the information on the system in which system the hacker is positioned.

Therefore, there has been required a technique capable of tracing back a hacker without a precise examination on a damaged system, e.g., the system 120, being performed thereto.

### SUMMARY OF THE INVENTION

It is, therefore, an object of the present invention to provide a system and method for providing a real-time attacking connection traceback (ACT) using of a packet watermark insertion technique by inserting a watermark into a response packet against a hacker's attack and forming a traceback path on the basis of information on the watermark-inserted packet, thereby performing an accurate and prompt traceback function without modifying or adjusting various information security devices.

In accordance with one aspect of the invention, there is provided a system for providing a system for providing a real-time attacking connection traceback using of a packet watermark insertion technique, the system including: an intrusion detection unit for detecting an attack of a hacker; a packet block unit for blocking a response of an attacked system on the basis of the attack of the hacker; a path tracing unit for generating a policy to block a specific packet through the packet block unit by using information on the attack of the hacker provided from the intrusion detection unit and a watermark, collecting a response packet from the attacked system, inserting the generated watermark in the packet, transmitting the watermark-inserted packet to a system through which the attack of the hacker is transmitted and forming a traceback path by using watermark-inserted packet detection information, wherein the watermark-inserted packet detection information is transmitted by an external attacking connection traceback system detecting the watermark-inserted packet; and a watermark detection unit for checking a received/transmitted packet in a network, extracting a corresponding watermark if there exists the watermark-inserted packet and transmitting the watermark-inserted packet detection information to an attacking connection traceback system that initially inserted the watermark into the packet.

In accordance with another aspect of the invention, there is provided a real-time attacking connection traceback method using of a packet watermark insertion technique in a real-time attacking connection traceback system having an intrusion detection unit, a packet block unit, a path tracing unit and a watermark detection unit, the method including the steps of: (a) detecting by the intrusion detection unit a hacking attempt of a hacker to attack an object system via a plurality of intermediate systems; (b) generating a policy to be used in the packet block unit by extracting an ID address of a system performing an attack and a port number thereof from hacking information detected by the intrusion detection unit; (c) generating a watermark in the path tracing unit based on the detected hacking information; (d) blocking by using the packet block unit a response of a damaged system generated due to the hacking attempt; (e) collecting the response of the damaged system by the path tracing unit, inserting the watermark generated in the step (c) into the response packet and transmitting the watermark-inserted packet to the attacking system; (f) checking whether there exists the watermark-inserted packet among packets received/transmitted in a network by the watermark detection unit and detecting the watermark-inserted packet, if there exists the watermark-inserted packet; (g) extracting information from the detected watermark; (h) transmitting the watermark-inserted packet and information on a connection corresponding to the watermark-inserted packet to the real-time attacking connection traceback system that initially inserted the watermark into the packet by using the information extracted from the watermark; and (i) determining an attack path and an actual location of the hacker by using the received watermark detection information.

### BRIEF DESCRIPTION OF THE DRAWINGS

The above and other objects and features of the present invention will become apparent from the following description of preferred embodiments, given in conjunction with the accompanying drawings, in which:

FIG. 1 shows an exemplary diagram of a general hacking process via a plurality of systems;

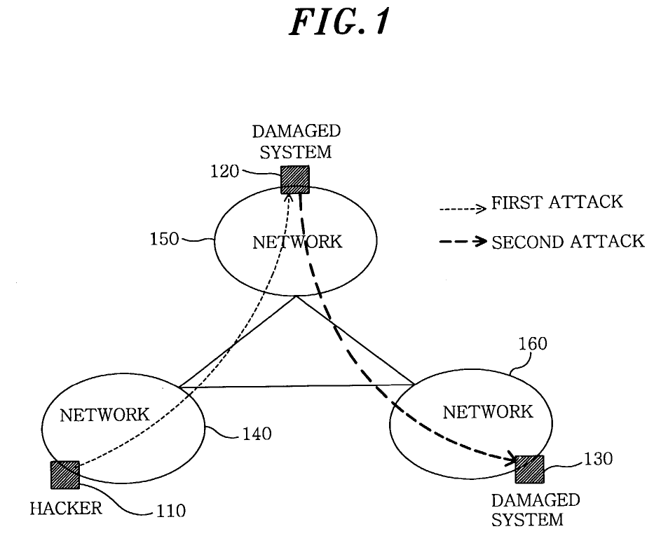

FIG. 2 illustrates a block diagram for showing an overall structure of a real-time attacking connection traceback system employed in the present invention;

FIG. 3 describes an operational process of an intrusion detection unit shown in FIG. 2 in accordance with the preferred embodiment of the present invention;

FIG. 4 depicts operational processes of a packet block unit, a path tracing unit and a watermark detection unit shown in FIG. 2 in accordance with another preferred embodiment of the present invention; and

FIG. 5 presents a diagram for illustrating a process for tracing a location of a hacker by detecting a watermark-inserted packet in accordance with still another preferred embodiment of the present invention.

### DETAILED DESCRIPTION OF THE PREFERRED EMBODIMENTS

Hereinafter, preferred embodiments of the present invention will be described in detail with reference to the accompanying drawings.

The present invention provides a real-time traceback technique for automatically tracing the source of intrusion.

Further, if intruders connect through a series of intermediate hosts before attacking the final target, the source of the intrusion can be detected, by inserting a watermark into network-based response packets generated from the hosts to track back the source of the intrusion on the basis of the watermark-inserted packet.

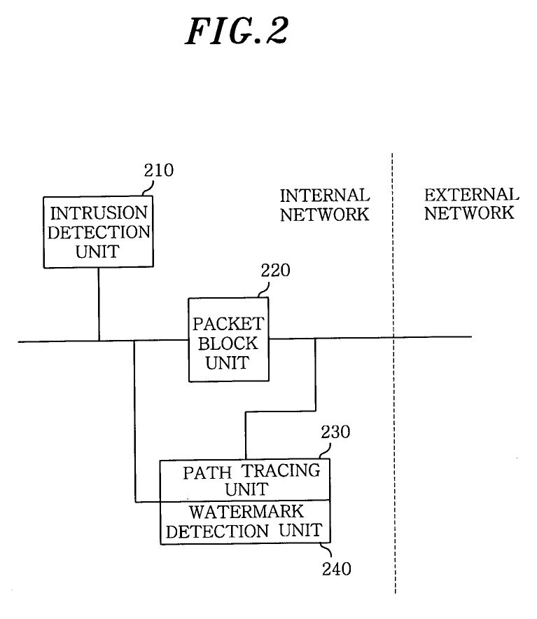

Referring to FIG. 2, there is schematically illustrated an overall structure of an attacking connection traceback (ACT) system in accordance with the present invention.

The ACT system in accordance with the present invention includes an intrusion detection unit 210, a packet block unit 220, a path tracing unit and a watermark detection unit 240.

The intrusion detection unit 210 detects an intrusion to inform the path tracking unit 230 of the intrusion when the intrusion is detected.

The packet block unit 220, e.g., a Firewall, blocks a packet corresponding to an IP address of a source and a port number of a destination designated by the path tracing unit 230.

The path tracing unit 230 receives connection information on the intrusion detected by the intrusion detection unit 210 and then notifies the packet block unit 220 of blocking response packets of intruded systems connected on the basis of the connection information. Further, the path tracing unit 230 collects the response packets of the intruded systems by continuously checking received/transmitted packets and generates watermarks to be applied to a corresponding attack to insert the watermarks into the collected response packets. Then, the watermark-inserted packets are sent to a system of the hacker. The path tracing unit 230 forms a traceback path by using the connection information with an external ACT system, i.e., an ACT system that detects the watermark-inserted packet transmitted from the path tracing unit 230.

The watermark detection unit 240 continuously checks the received/transmitted packets through a network to detect a watermark-inserted packet. If the watermark-inserted packet is detected, the watermark detection unit 240 transmits a watermark detection result to the ACT system that initially inserted a watermark into a packet by using information obtained from the detected watermark. The watermark detection unit 240 may be separately installed and operated only for detecting watermarks unlike other components in the ACT system, which will be apparent to those skilled in the art.

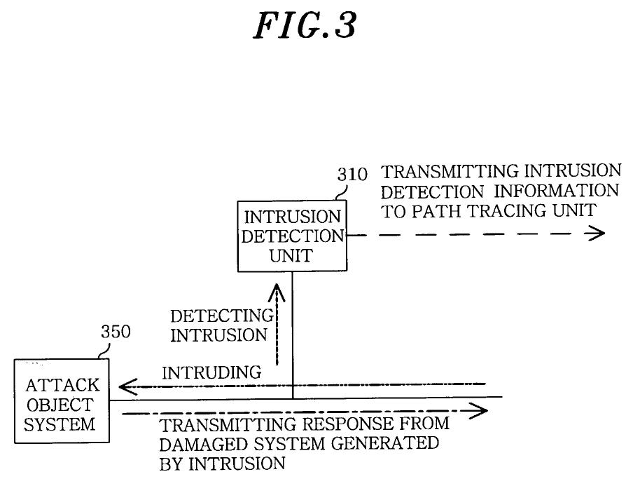

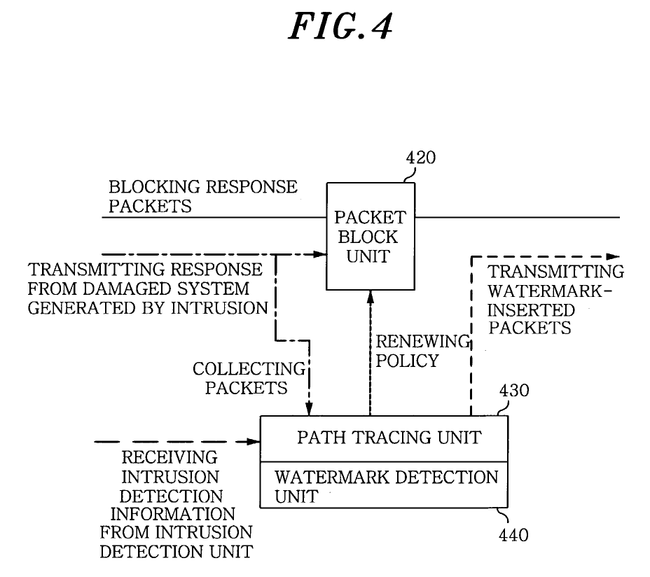

Referring to FIGS. 3 and 4, there is provided an operational process of an ACT system in an internal network.

An operation of an intrusion detection unit 310 as shown in FIG. 3 is described as follows.

When an initial intrusion on is detected on an attack object system 350 (step S1), the intrusion detection unit 310 detects the intrusion (step S2).

When the intrusion is detected, the intrusion detection unit 310 informs the path tracing unit 230 of the occurrence of the intrusion and connection information on paths used by the detected intrusion (step S3). Next, a response message to the attack is generated by the damaged system 350 (step S5).

FIG. 4, on the other hand, represents operations of a path tracing unit 430 receiving the intrusion detection information and a packet block unit 420.

When the intrusion detection information is received from the intrusion detection unit 310 as described in step S3, the path tracing unit 430 renews a policy of the packet block unit 420 by using corresponding information (step S4), wherein the renewed policy is used for blocking a response of a system damaged on the basis of an attack connection.

Thereafter, when the response of the damaged system is generated due to the attack (step S5), the path tracing unit 430 collects corresponding response packets (step S6) and inserts newly generated watermarks into the collected packets (step S8). Then, the watermark-inserted packets are sent to a system from which the attack is transmitted (step S9).

At this time, since the response generated from the damaged system is blocked by the packet block unit 420 (step S7), the system for performing the attack considers the watermark-inserted response as the response of an attacked system.

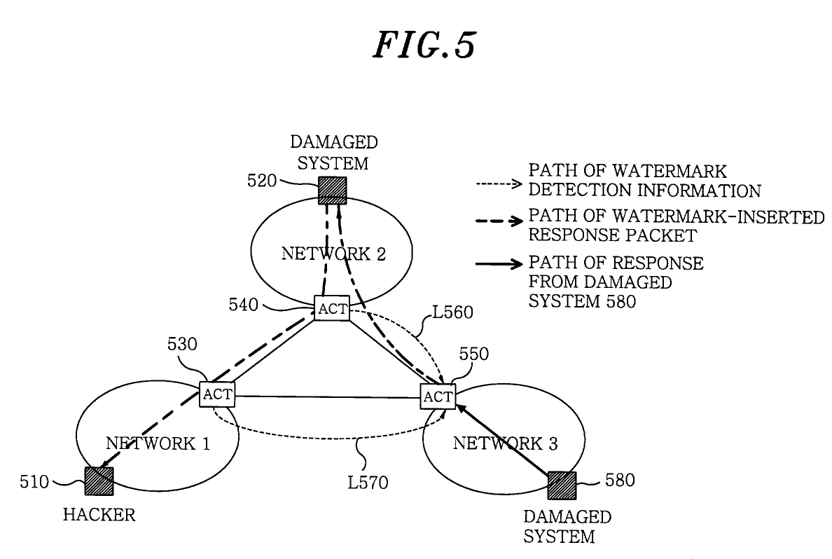

Referring to FIG. 5, there is schematically illustrated a case where a watermark-inserted packet is detected by an external ACT system in another network while actually being transmitted through a network.

As illustrated in FIG. 5, if the watermark-inserted response packet is transmitted to a damaged system 520 being attacked, a response packet corresponding to the attack is automatically sent to a final location 510 where an intrusion source, i.e., a hacker, exists, regardless of the number of intermediate systems. Therefore, the watermark-inserted packet is detected by a watermark detection unit of ACT systems 530 and 540 serving as networks in which the intermediate systems are located.

Thereafter, information is extracted from the detected watermark and the detected information is transmitted to an ACT system 550 through paths L560 & L570 that sent the initial watermark-inserted packet. Next, the ACT system 550 forms a traceback path by using the watermark-inserted packet detection information and then completes a location tracing of a hacker. As described above, the watermark detection unit may be separated from an entire ACT system, installed in a network and used therein.

The present invention makes it possible to promptly and accurately trace a location of a hacker even though the hacker attacks a specific system via a plurality of systems, thereby quickly and physically coping with the hacker.

While the invention has been shown and described with respect to the preferred embodiments, it will be understood by those skilled in the art that various changes and modifications may be made without departing from the spirit and scope of the invention as defined in the following claims.

What is claimed is:

1. A system for providing a real-time attacking connection traceback using of a packet watermark insertion technique, the system comprising:
an intrusion detection unit for detecting an attack of a hacker;
a packet block unit for blocking a response of an attacked system on the basis of the attack of the hacker;
a path tracing unit for generating a policy to block a specific packet through the packet block unit by using information on the attack of the hacker provided from the intrusion detection unit and a watermark, collecting a response packet from the attacked system, inserting the generated watermark in the packet, transmitting the watermark-inserted packet to a system through which the attack of the hacker is transmitted and forming a traceback path by using watermark-inserted packet detection information, wherein the watermark-inserted packet detection information is transmitted by an external attacking connection traceback system detecting the watermark-inserted packet; and
a watermark detection unit for checking a received/transmitted packet in a network, extracting a corresponding watermark if there exists the watermark-inserted packet and transmitting the watermark-inserted packet detection information to an attacking connection traceback system that initially inserted the watermark into the packet.

2. A real-time attacking connection traceback method using of a packet watermark insertion technique in a real-time attacking connection traceback system having an intrusion detection unit, a packet block unit, a path tracing unit and a watermark detection unit, the method comprising the steps of:
(a) detecting by the intrusion detection unit a hacking attempt of a hacker to attack an object system via a plurality of intermediate systems;
(b) generating a policy to be used in the packet block unit by extracting an ID address of a system performing an attack and a port number thereof from hacking information detected by the intrusion detection unit;
(c) generating a watermark in the path tracing unit based on the detected hacking information;
(d) blocking by using the packet block unit a response of a damaged system generated due to the hacking attempt;
(e) collecting the response of the damaged system by the path tracing unit, inserting the watermark generated in the step (c) into the response packet and transmitting the watermark-inserted packet to the attacking system;
(f) checking whether there exists the watermark-inserted packet among packets received/transmitted in a network by the watermark detection unit and detecting the watermark-inserted packet, if there exists the watermark-inserted packet;
(g) extracting information from the detected watermark;
(h) transmitting the watermark-inserted packet and information on a connection corresponding to the watermark-inserted packet to the real-time attacking connection traceback system that initially inserted the watermark into the packet by using the information extracted from the watermark; and
(i) determining an attack path and an actual location of the hacker by using the received watermark detection information.

3. The method of claim 2, wherein the path tracing unit further includes the steps of:
(a′) receiving attack information of the hacker from the intrusion detection unit;
(b′) generating the policy to block the specific packet through the packet block unit by using the received attack information;
(c′) generating the watermark by using the received attack information;
(d′) collecting the response packet of the damaged system due to the attack of the hacker;
(e′) inserting the generated watermark into the response packet of the damaged system;
(f′) transmitting the watermark-inserted packet to the attacking system; and
(g′) forming a traceback path by using watermark-inserted packet detection information transmitted by an external real-time attacking connection traceback system detecting the transmitted watermark-inserted packet.
